(19) United States
(12) Patent Application Publication
(10) Pub. No.: US 2012/0131071 A1
(43) Pub. Date: May 24, 2012

(54) APPARATUS AND METHOD FOR PROVIDING E-NOTE FUNCTION IN MOBILE TERMINAL

(75) Inventor: Ji-Hwa KIM, Seongnam-si (KR)

(73) Assignee: SAMSUNG ELECTRONICS CO. LTD., Suwon-si (KR)

(21) Appl. No.: 13/298,503

(22) Filed: Nov. 17, 2011

(30) Foreign Application Priority Data
Nov. 18, 2010 (KR) 10-2010-0114807

(51) Int. Cl. G06F 17/30

(52) U.S. Cl. 707/821; 707/E17.008

(57) ABSTRACT

An apparatus and a method for providing an Electronic-note (E-note) function in a mobile terminal are provided. More particularly, an apparatus and a method for loading an Electronic-book (E-book) corresponding to a note through searching of contents of an E-note file by providing an E-note function that interacts with an E-book function in a mobile terminal. The apparatus includes a controller, a note manager, a display unit, and an input unit. The controller controls an E-book application that loads a book file and outputs book contents. The note manager manages an E-note application that generates an E-note corresponding to the book file when loading the book file. The display unit displays contents of the book file and the E-note. The input unit inputs notes regarding the book file into the E-note.

### PRIORITY

This application claims the benefit under 35 U.S.C. §119(a) of a Korean patent application filed in the Korean Intellectual Property Office on Nov. 18, 2010 and assigned Serial No. 10-2010-0114807, the entire disclosure of which is hereby incorporated by reference.

### BACKGROUND OF THE INVENTION

1. Field of the Invention

The present invention relates to an apparatus and a method for providing an Electronic-note (E-note) function in a mobile terminal. More particularly, the present invention relates to an apparatus and a method for loading an Electronic-book (E-book) corresponding to a note through searching of contents of an E-note file by providing an E-note function that interacts with an E-book function in a mobile terminal.

2. Description of the Related Art

Mobile terminals are widely distributed and used due to their convenience in portability. Therefore, service providers that are terminal manufacturers competitively develop mobile terminals having special functions in order to attract more users. For example, mobile terminals provide various functions such as a phonebook, games, a scheduler, a Short Message Service (SMS), wireless Internet access, Electronic-mail (E-mail) services, an alarm, a Motion Picture Expert Group Audio Layer-3 (MP3) player, a digital camera, an electronic dictionary, and other similar products, functions and services.

Recently, E-books have grown in popularity and increasingly replace paper books as information and text media displaying devices. The E-book stores text contents and/or book data in a flash memory or a built-in hard disk drive, and then shows the stored text contents via a display screen. The E-book has an advantage of storing a large amount of book data at a time and then selectively showing desired contents. Using an E-book function, a user may add notes to a book read by the user, wherein the added notes may be stored with the book data on the E-book, or write his opinion on the book through the E-book function. The user may view the written contents, such as the added notes or opinion, afterward, such that the E-book function is widely used for learning.

However, the above-described E-book function allows the user to write notes in an E-book file using an E-book application. To view the written contents, the user has to locate a corresponding E-book file and execute the same. The above problem occurs because the contents or notes written through the E-book function are not managed separately by the E-book. When the user's notes increase, the user cannot view a book file where specific notes have been written. Therefore, to address the above problem, an apparatus and a method for providing a separate note function and allowing the note function to interact with an E-book function are needed.

### SUMMARY OF THE INVENTION

Aspects of the present invention are to address at least the above-mentioned problems and/or disadvantages and provide at least the advantages described below. Accordingly, an aspect of the present invention is to provide an apparatus and a method for providing an E-book function that interacts with an Electronic-note (E-note) in a mobile terminal.

Another aspect of the present invention is to provide an apparatus and a method for generating an E-note corresponding to an Electronic-book (E-book) in a mobile terminal.

Still another aspect of the present invention is to provide an apparatus and a method for loading an E-book by executing an E-note in a mobile terminal.

In accordance with an aspect of the present invention, an apparatus for providing an Electronic-note (E-note) function in a mobile terminal is provided. The apparatus includes a note manager for generating a note file corresponding to a book file when performing an Electronic-book (E-book) function and adding notes corresponding to the book file to the note file, and a controller for storing the note file generated by the note manager.

In accordance with another aspect of the present invention, a method for providing an E-note function in a mobile terminal is provided. The method includes generating a note file corresponding to a book file when performing an E-book function, for adding notes written in the book file to the note file, and storing the note file.

In accordance with still another aspect of the present invention, an apparatus for providing an E-note function in a mobile terminal is provided. The apparatus includes a controller for controlling an E-book application that loads a book file and outputs book contents, a note manager for managing an E-note application that generates an E-note corresponding to the book file when loading the book file, a display unit for displaying contents of the book file and the E-note, and an input unit for inputting notes corresponding to the book file into the E-note.

In accordance with yet another aspect of the present invention, a method for providing an E-note function in a mobile terminal is provided. The method includes executing an E-book application that loads a book file and outputs book contents, executing an E-note application that generates an E-note corresponding to the book file when loading the book file, displaying contents of the book file and the E-note, and inputting notes corresponding to the book file into the E-note.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a mobile terminal that allows an E-book function to interact with a note function according to an exemplary embodiment of the present invention;

FIG. 2 is a flowchart illustrating a process for executing an Electronic-book (E-book) function in a mobile terminal according to an exemplary embodiment of the present invention;

FIG. 3 is a flowchart illustrating a process for executing a stored note in a mobile terminal according to an exemplary embodiment of the present invention;

FIG. 4A is a view illustrating a mobile terminal having two output panels according to an exemplary embodiment of the present invention;

FIG. 4B is a view illustrating a mobile terminal having one output panel according to an exemplary embodiment of the present invention;

FIG. 5A is a view illustrating a process for allowing a plurality of book files to interact with one note file in a mobile terminal according to an exemplary embodiment of the present invention;

FIG. 5B is a view illustrating a process for allowing a book file to interact with each note file in a mobile terminal according to an exemplary embodiment of the present invention;

FIGS. 6A to 6C are views illustrating a process for executing a note file in a mobile terminal according to an exemplary embodiment of the present invention; and

FIGS. 7A to 7C are views illustrating a process for executing a note file in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for providing an Electronic-book (E-book) function that interacts with an Electronic-note (E-note) in a mobile terminal.

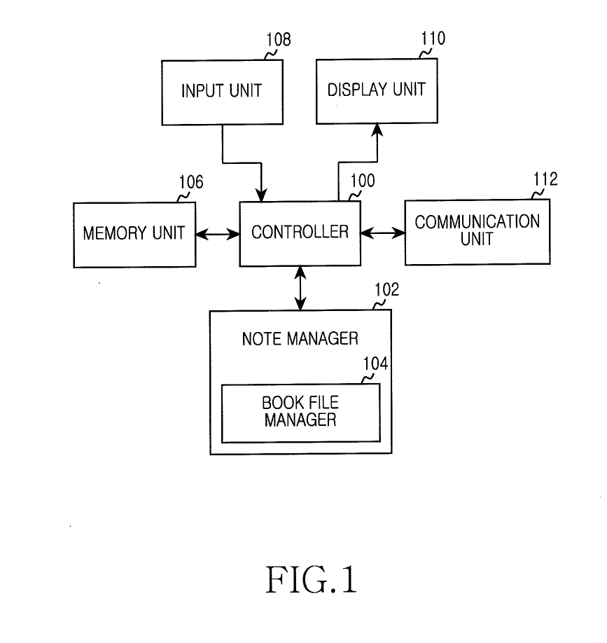

FIGS. 1 through 7, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile terminal that allows an E-book function to interact with a note function according to an exemplary embodiment of the present invention.

Referring to FIG. 1, the mobile terminal includes a controller 100, a note manager 102, a memory unit 106, an input unit 108, a display unit 110, and a communication unit 112. The note manager 102 may include a book file manager 104. The mobile terminal may include additional units that are not illustrated here merely for sake of clarity. Similarly, the functionality of two or more of the above units may be integrated into a single component.

The controller 100 of the mobile terminal controls an overall operation of the mobile terminal For example, the controller 100 performs processes and control operations for voice communication and data communication. In addition to the general communication functions, according to an exemplary embodiment of the present invention, the controller 100 allows an E-book function to interact with an E-note function.

That is, when executing an E-book function, the controller 100 generates a note file corresponding to a book file to allow a user to write notes. When executing a note file stored in advance, the controller 100 executes operations to load a book file that interacts with the note file.

The note manager 102 generates note data corresponding to a book file when loading the book file under control of the controller 100, and adds notes generated by the user to the generated note data. In addition, the note manager 102 outputs the written note data to a relevant file and loads the book file that interacts with the note file when executing the note file. The book file manager 104 of the note manager 102 processes the operations allowing the cooperation of the note file and the book file, and searches for a book file corresponding to a note file when executing the note file under the control of the note manager 102.

Although not shown, the memory unit 106 includes Read Only Memory (ROM), Random Access Memory (RAM), a flash ROM, or other similar storage devices. The ROM stores microcodes of programs for processes and control operations of the controller 100 and the note manager 102, and also stores various reference data and other user generated data. The RAM serves as a working memory of the controller 100 and stores temporary data that occur during execution of various programs. In addition, the flash ROM stores various updatable data for storage such as a phonebook, calling messages, received messages, information of a user's touch input point, and other similar data.

The input unit 108 includes a plurality of function keys, such as numerical key buttons of 0 to 9, a menu button, a cancel button, an OK button, a TALK button, an END button, an Internet access button, navigation key (directional key) buttons, letter input keys, etc., and provides key input data corresponding to a key pressed by a user to the controller 100. Furthermore, although not shown, the input unit 108 may be a touch input device allowing a user to provide key input data via a display device including a touch input device.

The display unit 110 displays status information generated during an operation of the mobile terminal, characters, a large amount of moving images and still images, etc. The display unit 110 may be a color Liquid Crystal Display (LCD), an Active Matrix Organic Light Emitting Diode (AMOLED) display, and other similar display apparatuses. The display unit 110 may include the touch input device, and when it is applied to a touch input type mobile terminal, it can be used as an input unit.

The communication unit 112 transmits/receives a Radio Frequency (RF) signal of data input/output via an antenna (not illustrated). For example, during transmission, the communication unit 112 channel-codes and spreads data to be transmitted, and then performs an RF process on the signal to transmit the signal. During reception, the communication unit 112 converts a received RF signal into a baseband signal, and despreads and channel-decodes the baseband signal to recover data.

The function of the note manager 102 may be performed by the controller 100 of the mobile terminal. As shown in FIG. 1, the separate configuration and illustration of the note manager 102 is for an exemplary purpose only for convenience of description. However, aspects of the present invention are not limited thereto, and various modifications to the note manager 102 configuration may be made within the scope of the present invention. For example, all functions of the note manager 102 may be processed by the controller 100.

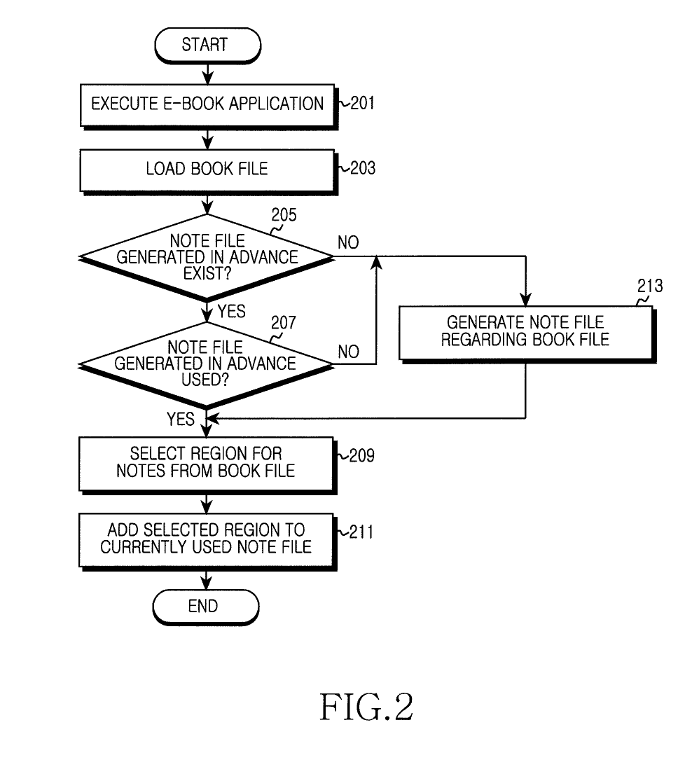

FIG. 2 is a flowchart illustrating a process for executing an E-book function in a mobile terminal according to an exemplary embodiment of the present invention.

Referring to FIG. 2, the E-book function may be performed by executing or running an E-book application of the mobile terminal and loading a book file. To execute the E-book function, the mobile terminal executes an E-book application in step 201 first, and proceeds to step 203 to load a book file that a user desires to load through the E-book application.

The mobile terminal proceeds to step 205 to determine whether a note generated in advance exists. Here, when loading a book file, the mobile terminal may generate a note file that interacts with the loaded book file, and a user of the mobile terminal may generate a note file to write notes for each book file, or may perform writing notes regarding a plurality of book files in one note file. Therefore, the mobile terminal determines whether a note file corresponding to a previous book file loading is to be generated or determines whether to load a note file that is previously stored in order to perform writing notes regarding a book file in step 205.

When the note file generated in advance does not exist or the note file stored in advance is not loaded for writing notes regarding the book file in step 205, the mobile terminal proceeds to step 213 to newly generate a note file corresponding to a book file.

When the note file generated in advance exists in step 205, the mobile terminal proceeds to step 207 to determine whether to perform writing notes using the note file generated in advance. At this point, the note file generated in advance may be a note file corresponding to another book file that was loaded in advance before the loading of the book file of step 203.

Upon determining that the note file generated in advance is not used in step 207, the mobile terminal proceeds to step 213 to generate a note file corresponding to the loaded book file and prepares to perform writing notes on the generated note file. Here, the preparing to perform the writing of notes proceeds step 209 in order to allow a user to determine contents of a book file to be added to a note file.

Upon determining that the note file generated in advance is used in step 207, the mobile terminal proceeds to step 209 to allow a user to determine contents of a book file to be added to a note file by selecting a region of a book file on which the user desires to write notes. At this point, the mobile terminal may determine the region on which the user desires to write notes by detecting the user's touch movement, such as tapping on, highlighting, or underlining a region of the book file or detecting block designation that is a user input for setting a region of a book file on which the user desires to write notes.

The mobile terminal proceeds to step 211 to add the region selected by the user in step 209 to a currently used note file. At this point, the mobile terminal adds information regarding a main book file corresponding to the note file, information regarding a reference book file, region information of a book file including written contents, such as page and line information, a user's opinion regarding written contents, or other similar information, to the note.

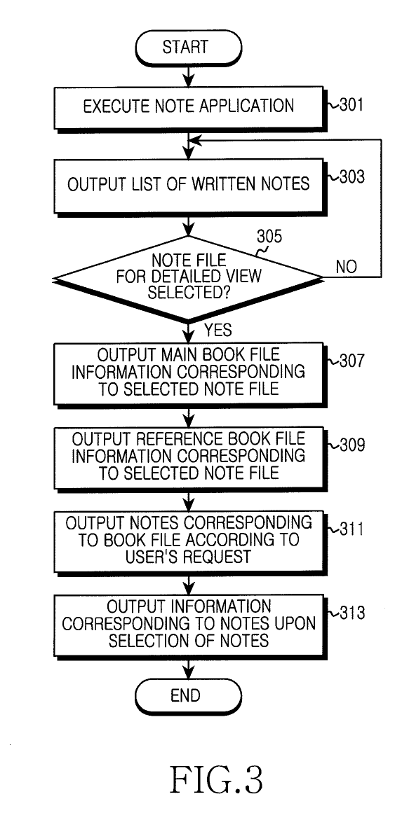

FIG. 3 is a flowchart illustrating a process for executing a stored note in a mobile terminal according to an exemplary embodiment of the present invention.

Referring to FIG. 3, the mobile terminal executes a note application in step 301, and proceeds to step 303 to output a list of written notes. That is, the mobile terminal outputs the list of note files stored in a memory on a display unit. At this point, the mobile terminal outputs book file information corresponding to each note file in order to allow a user to conveniently select a note file corresponding to a book file that the user desires to locate.

Next, the mobile terminal proceeds to step 305 to determine whether selection of a note file for a detailed view is detected. Here, the selecting of the note file for the detailed view allows for a determining of contents, such as contents of a specific region regarding a book file, a user's opinion regarding a book file, or other similar information, contained in a note file.

When the selection of the note file for the detailed view is not detected in step 305, the mobile terminal re-performs the process of step 303.

In contrast, when the selection of the note file for the detailed view is detected in step 305, the mobile terminal proceeds to step 307 to output main book file information corresponding to the selected note file, and proceeds to step 309 to output reference book file information corresponding to the selected note file.

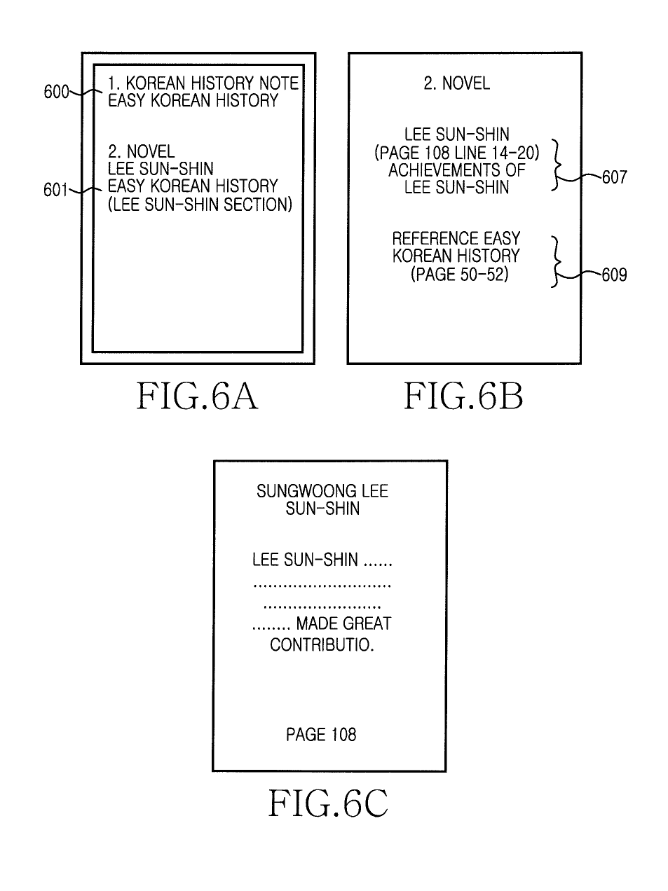

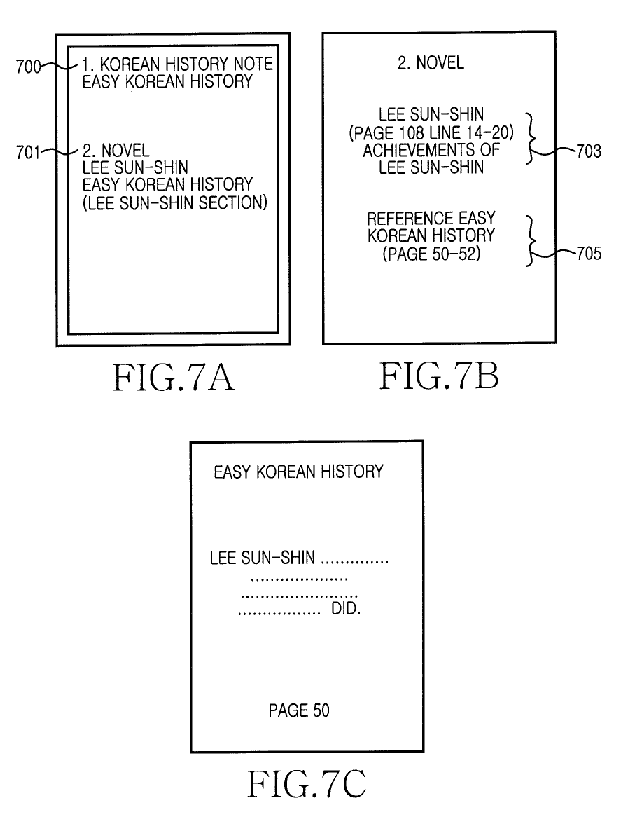

The mobile terminal proceeds to step 311 to output notes contained in the note file and corresponding to a book file according to the user's request, and proceeds to step 313 to output information corresponding to selected notes when the user selects the notes. Contents corresponding to a main book, a reference book, and note files are described in more detail with reference to FIGS. 6 and 7. Therefore, the user of the mobile terminal may load a book file related to notes or easily view information regarding the book file through a note file having written notes therein.

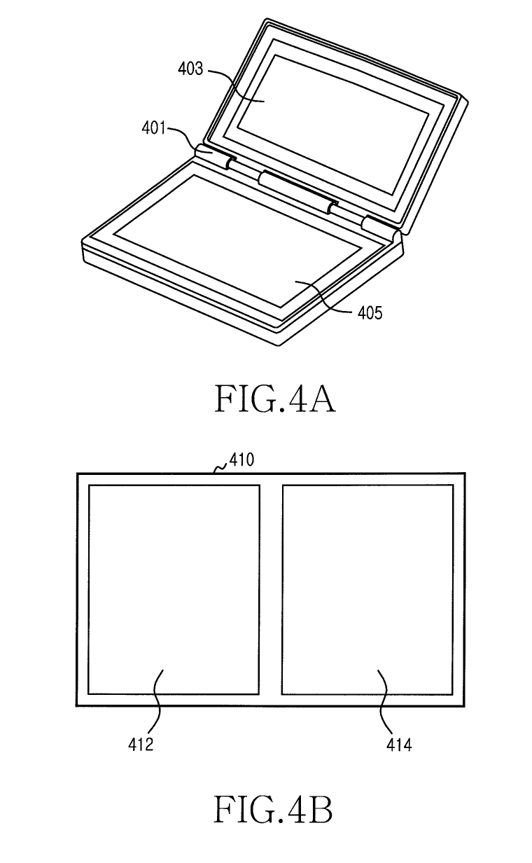

FIG. 4A is a view illustrating a mobile terminal having two output panels according to an exemplary embodiment of the present invention.

Referring to FIG. 4A, the mobile terminal has two output panels 403 and 405. At this point, the output panels 403 and 405 are connected to each other with a hinge 401 and are rotatable around the hinge 401 by a predetermined angle of rotation, such as 90°. However, the present invention is not limited thereto, and the output panels 403 and 405 may be rotatable around the hinge 401 by any suitable angle of rotation, and may be connected to each other using any suitable element.

The mobile terminal may output a book file and a note file via a large screen, and the size of the mobile terminal may be reduced in order to be suitable for portability when the panels are folded. At this point, the mobile terminal may load a book file on the first output panel 403 and output a note file on the second output panel 405. However, the present invention is not limited thereto, and the book file and the note file may be displayed on the first output panel 403 and the second output panel 405 in any suitable manner.

FIG. 4B is a view illustrating a mobile terminal having one output panel according to an exemplary embodiment of the present invention.

Referring to FIG. 4B, the mobile terminal divides one output panel 410 into two output regions, which are a first region 412 and a second region 414, in order to display a book file and a note file. The structure illustrated in FIG. 4B is suitable for a mobile terminal that is formed so as to be portable and may output a book file on the first region 412 and output a note file on the second region 414. However, the present invention is not limited thereto, and the book file and the note file may be displayed on the first region 412 and the second region 414 in any suitable manner.

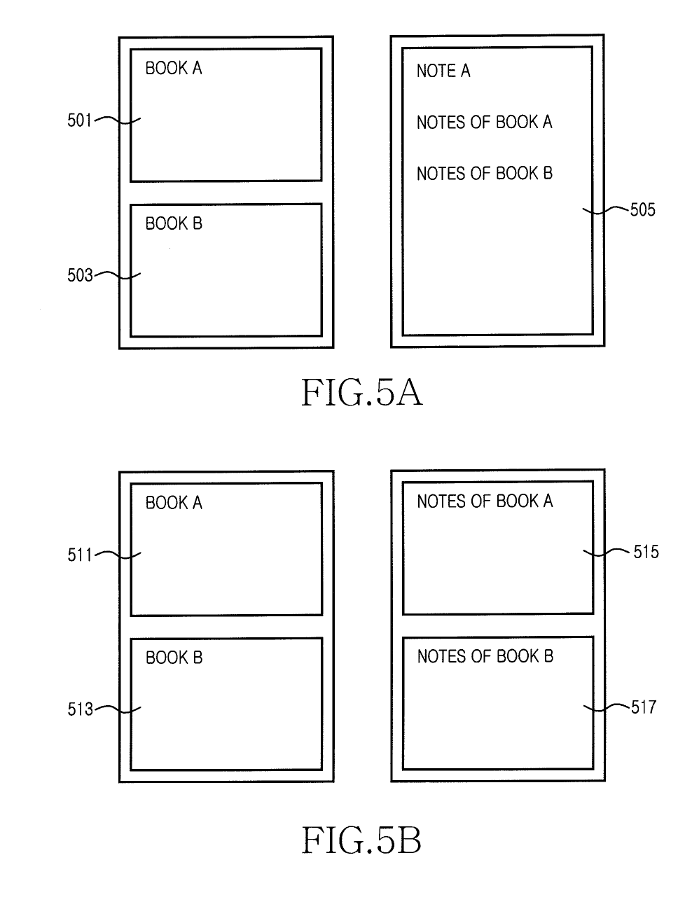

FIG. 5A is a view illustrating a process for allowing a plurality of book files to interact with one note file in a mobile terminal according to an exemplary embodiment of the present invention.

Referring to FIG. 5A, the mobile terminal may start generating note files corresponding to a book A by generating a note A file 505, which is a note file, when loading a book A file 501, which is a book file. In the case where a book B file 503, which is a book file, is loaded according to a user's request while the mobile terminal loads the book A file 501, to allow for writing notes as described above, the mobile terminal outputs a menu for allowing the user to select whether to generate a note file corresponding to the book B file 503. The present case is illustrated in FIG. 5A, which simultaneously illustrates the book A file 501 and the book B file 503 for representing a case where the user loads two book files. However, the present invention is not limited thereto, and the present invention is applicable to a case where a plurality of book files are simultaneously loaded on one screen or a plurality of screens in a variety of combinations.

Accordingly, depending on the user's selection, the mobile terminal may execute the notes function so as to correspond to a plurality of book files in one note file, or to execute the notes function in a plurality of note files respectively corresponding to each book file. As illustrated in FIG. 5A, the reference numeral 505 denotes a note A file, which is a note file corresponding to the book A file 501. The note A file 505 stores notes corresponding to the book “A” 501 and the notes corresponding to the book “B” 503 book file together.

FIG. 5B is a view illustrating a process for allowing a book file to interact with each note file in a mobile terminal according to an exemplary embodiment of the present invention.

Referring to FIG. 5B, as described above, the mobile terminal may start note files corresponding to a book A file 511 by generating a note A file 515 when loading the book A file 511.

In the case where a book B file 513 is loaded, according to a user's request, while the mobile terminal loads the book A file 511 and allows for the generation of notes, the mobile terminal outputs a menu allowing the user to select whether to generate a note file corresponding to the book B file 513. Accordingly, depending on the user's selection, the mobile terminal may allow for the writing of notes corresponding to a plurality of book files in one note file, or may allow for the writing notes in a plurality of note files respectively corresponding to each book file of the plurality of book files.

As illustrated, notes corresponding to the book A file 511 are written in a note A file 515 corresponding to the book A file 511, and notes corresponding to the book B file 513 are written on a note B file 517 corresponding to the book B file 513.

FIGS. 6A to 6C are views illustrating a process for executing a note file in a mobile terminal according to an exemplary embodiment of the present invention.

Referring to FIGS. 6A to 6C, when executing a note application, the mobile terminal outputs a list of note files stored in advance, as illustrated in FIG. 6A. The mobile terminal stores a Korean History note file 600 and a Novel note file 601.

The Korean History note file 600 is for notes regarding an Easy Korean History book file (not shown), and the Novel note file 601 is for notes regarding a Lee Sun-Shin book file (not shown) and an Easy Korean History (Lee Sun-Shin section) book file (not shown). That is, the Novel note 601 is a note file including notes corresponding to two book files, and the Korean History note 600 is a note file including notes corresponding to only the Easy Korean History book file.

When one note file from among the note files 600 and 601 is selected from the list of the note files stored in advance, as shown in FIG. 6A, the mobile terminal outputs detailed information and contents of the selected note file. For example, as shown in FIG. 6B, when a user selects the Novel note file 601, the mobile terminal outputs notes 607 regarding achievements of Lee Sun-Shin which correspond to the Lee Sun-Shin book file and notes 609 regarding Korean history which correspond to the Easy Korean History (Lee Sun-Shin section) book file.

When the user of the mobile terminal selects information regarding the notes 607 or the notes 609, the mobile terminal may load the book file corresponding to the selected information, as illustrated in FIG. 6C. The mobile terminal may directly load a page of the book file including the notes contents when loading the book file. For example, as illustrated in FIG. 6C, in the case where the user of the mobile terminal selects notes 607 regarding the LEE Sun-Shin book file, the mobile terminal loads the Lee Sun-Shin book file and loads an appropriate page of the book file selected by the user in order to directly output contents of the relevant region, that being page 108 of the Lee Sun-Shin book file, corresponding to the notes 607.

FIGS. 7A through 7C are views illustrating a process for executing a note file in a mobile terminal according to an exemplary embodiment of the present invention.

Referring to FIG. 7A through 7C, when executing a note application, the mobile terminal outputs a list of note files stored in advance, as illustrated in FIG. 7A. The mobile terminal stores a Korean History note file 700 and a Novel note file 701.

The Korean History note file 700 is for notes regarding an Easy Korean History book file (not shown), and the Novel note file 701 is for notes regarding a Lee Sun-Shin book file (not shown) and the Easy Korean History (Lee Sun-Shin section) book file (not shown). That is, the Novel note 701 is a note file including notes corresponding to two book files, and in contrast, the Korean History Note 700 is a note file including notes corresponding to only the Easy Korean History book file.

When one note file from among the note files 700 and 701 is selected from the list of the note files stored in advance, as shown in FIG. 7A, the mobile terminal outputs detailed information and contents of the selected note file. For example, as shown in FIG. 7B, when a user selects the Novel note file 701, the mobile terminal outputs notes 703 regarding achievements of Lee Sun-Shin which correspond to the Lee Sun-Shin book file and notes 705 regarding Korean history which correspond to the Easy Korean History (Lee Sun-Shin section) book file, as illustrated in FIG. 7B.

When a user of the mobile terminal selects information or specific notes, from among the notes 703 and 705, regarding the Lee Sun-Shin book file or the Easy Korean History book file, the mobile terminal may load the book file with respect to the selected information. In other words, the mobile terminal may directly load a page of the book file including the notes contents when loading the book file. For example, as illustrated in FIG. 7C, in the case where the user of the mobile terminal selects notes 705 regarding the Easy Korean History book file, the mobile terminal loads the Easy Korean History book file and loads a region page of the book file selected by the user to directly output contents of the relevant region, that being page 50 of the Easy Korean History book file, corresponding to the notes 705.

As described above, exemplary embodiments of the present invention are for interaction of an E-book function and an E-note function in a mobile terminal. In the case where notes by a user occur while the E-book function is executed, exemplary embodiments of the present invention generate an E-note file corresponding to the E-book and add the notes to the generated E-note file, so that the generated E-note may be viewed separately from the E-book.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing an Electronic-note (E-note) function in a mobile terminal, the apparatus comprising:
a note manager for generating a note file corresponding to a book file when performing an Electronic-book (E-book) function and for adding notes corresponding to the book file to the note file; and
a controller for storing the note file generated by the note manager.

2. The apparatus of claim 1, wherein the note manager adds notes to a note file respectively corresponding to the book file from among a plurality of book files.

3. The apparatus of claim 1, wherein the note manager adds notes to a note file corresponding to a plurality of book files.

4. The apparatus of claim 1, wherein when loading the note file, the note manager outputs information of notes written in the note file and loads the book file corresponding to the note file according to a user's selection.

5. The apparatus of claim 1, wherein the note manager loads a page of a corresponding book file, and
wherein the page corresponds to the notes of the note file.

6. The apparatus of claim 1, wherein the notes corresponding to the note file comprise at least one of information of a first book file, information of a second book file, and a page of the book file corresponding to the notes.

7. The apparatus of claim 1, wherein the note file is stored in a manner corresponding to a respective book file or a plurality of book files.

8. The apparatus of claim 1, further comprising a memory unit, wherein the controller outputs a list of a plurality of note files stored on the memory unit.

9. The apparatus of claim 8, wherein the controller outputs a note file selected by a user from among the plurality of note files stored on the memory unit.

10. A method for providing an Electronic-note (E-note) function in a mobile terminal, the method comprising:
generating a note file corresponding to a book file when performing an Electronic-book (E-book) function;
adding notes written in the book file to the note file; and
storing the note file.

11. The method of claim 10, wherein the adding of the notes written in the book file to the note file comprises adding notes to a note file respectively corresponding to the book file from among a plurality of book files.

12. The method of claim 10, wherein the adding of the notes written in the book file comprises adding notes to a note file corresponding to a plurality of book files.

13. The method of claim 10, further comprising:
loading the note file and outputting information of notes written in the note file; and
loading the book file corresponding to the note file according to a user's selection.

14. The method of claim 13, wherein the loading of the book file corresponding to the note file comprises loading a page of the corresponding book file,
wherein the page corresponds to the notes of the note file.

15. The method of claim 10, wherein the notes corresponding to the note file comprise at least one of information of a first book file, information of a second book file, and a page of the book file corresponding to the notes.

16. The method of claim 10, wherein the storing of the note file comprises storing the note file in a manner corresponding to a respective book file or a plurality of book files.

17. The method of claim 10, further comprising outputting a list of a plurality of stored note files.

18. The method of claim 17, further comprising outputting a note file selected by a user from among the plurality of stored note files.

19. An apparatus for providing an Electronic-note (E-note) function in a mobile terminal, the apparatus comprising:
a controller for controlling an Electronic-book (E-book) application that loads a book file and outputs book contents;
a note manager for managing an E-note application that generates an E-note corresponding to the book file when loading the book file;
a display unit for displaying contents of the book file and the E-note; and
an input unit for inputting notes corresponding to the book file into the E-note,
wherein the note manager adds notes to the E-note corresponding to the book file and stores the notes, and allows the book file to interact with the E-note and stores the E-note.

20. The apparatus of claim 19, wherein the note manager outputs notes included in the E-note when loading the E-note that interacts with the book file.

21. A method for providing an Electronic-note (E-note) function in a mobile terminal, the method comprising:
executing an Electronic-book (E-book) application that loads a book file and outputs book contents;
executing an Electronic-note E-note) application that generates an E-note corresponding to the book file when loading the book file;
displaying contents of the book file and the E-note; and
inputting notes regarding the book file into the E-note,
wherein the driving of the E-note application comprises:
adding notes to the E-note corresponding to the book file; and
allowing the book file to interact with the E-note and storing the E-note.

22. The method of claim 21, wherein the executing of the E-note application further comprises:
outputting notes included in the E-note when loading the E-note that interacts with the book file.
